(19) United States
(12) Patent Application Publication
(10) Pub. No.: US 2025/0210967 A1
(43) Pub. Date: Jun. 26, 2025

(54) SUPERCONDUCTING ELECTRICAL SUPPLY LINE, METHOD FOR CONTROLLING A SUPERCONDUCTING ELECTRICAL SUPPLY LINE AND AIRCRAFT COMPRISING SUCH A LINE

(71) Applicants: Airbus SAS, BLAGNAC (FR); Airbus Operations SAS, TOULOUSE (FR)

(72) Inventors: Ludovic YBANEZ, BLAGNAC (FR); Alexandre COLLE, BLAGNAC (FR); Jean-François ROUQUETTE, BLAGNAC (FR); Ravi Kiran SURAPANENI, BLAGNAC (FR); Gowtham GALLA, BLAGNAC (FR)

(21) Appl. No.: 18/985,158

(22) Filed: Dec. 18, 2024

(30) Foreign Application Priority Data
Dec. 22, 2023 (FR) 2315164

(51) Int. Cl. H02H 7/00

(52) U.S. Cl. CPC H02H 7/001

(57) ABSTRACT

A method for controlling a superconducting electrical supply line that is carried out in a control circuit obtains a piece of information representative of a first electric current in the superconducting electrical supply line, then, when the piece of information representative of a first electric current is greater than or equal to a first predetermined threshold value, generates a current, referred to as the second current, in a superconducting coil arranged in the vicinity of the supply line, the value of the second current being determined on the basis of the piece of information representative of the first current. A control circuit is configured to implement the method. Current limiter functions are reversibly performed by initiating a quench phenomenon in the superconducting electrical supply line.

### CROSS-REFERENCES TO RELATED APPLICATIONS

This application claims the benefit of French Patent Application Number 2315164 filed on Dec. 22, 2023, the entire disclosure of which is incorporated herein by way of reference.

### FIELD OF THE INVENTION

The present invention relates to a superconducting electrical supply circuit equipped with a current controller. The invention relates, more particularly, to the monitoring and control of the integrity of an aircraft superconducting supply link, and an aircraft comprising such a supply link.

### BACKGROUND OF THE INVENTION

The aeronautical industry is making profound changes in terms of aircraft design, with the aim of significantly reducing emissions of carbon dioxide and nitrogen oxides, due to ecological and sustainable development constraints.

The use of liquid hydrogen as an energy source for an aircraft is a promising route for achieving this. Hydrogen can be used in a fuel cell, for generating electricity, or directly as a fuel in an engine unit. Moreover, work is specifically aimed at optimizing electric or hybrid propulsion systems for aircraft, and hydrogen that is present in liquid form aboard an aircraft can be used to increase the performance of electrical equipment by lowering its resistivity and consequently reducing Joule effect losses. It is also possible to use superconducting components. Superconducting conductors can be used for power distribution in architectures comprising diverse electrical components supplied with power by superconducting power distribution networks. In such electrical supply architectures, the superconducting link between a source and a load must be protected against unexpected transition from the superconducting state to the conventional state (a transition usually called a quench in the field of superconductivity). It is therefore important to be able to detect signs of such a transition in order to avoid an excessive loss through the Joule effect of the type that would damage the electrical supply circuits and their close environment.

In addition, the faults which occur in such power distribution networks must be treated quickly and reliably in order to avoid any damage to the systems.

Fault current limiters have current limitation characteristics that are calibrated at manufacture and are not very adaptable to specific conditions during their use. In addition, although superconducting fuse devices can ensure that the current is cut in branches of a superconducting distribution network, their activation is irreversible and requires replacement and thus a maintenance operation. Finally, semiconductor power circuit breaker devices, often called “solid state circuit breakers”, can also be used to effect cuts in branches of a superconducting power distribution network, but they present a risk to the integrity of the systems in the event of failure. In addition, semiconductor power circuit breakers have large Joule-effect losses in nominal operation.

In addition, the impedance of such power distribution networks is lower than the impedance standards of electrical networks conventionally incorporated in an aircraft. In conventional networks, the distribution, as well as the cables, contribute impedances which act as a damper for current variations, which has a stabilizing effect on the network. With superconducting technologies, attaining a zero resistivity for direct current, in particular in cables, presents a major disadvantage in terms of the stability of the network. In the case of a low impedance network, the stability margins of the network are reduced or even eliminated, which threatens the compatibility of the source and the loads which are connected to this common network, and can lead to an unstable network. The systems supplied cannot operate under these conditions, and may be damaged.

The situation can be improved.

### SUMMARY OF THE INVENTION

An object of the present invention is to propose a method which can obtain reversible current limitation functions in a superconducting electrical supply line, reproducing the functions of a traditional fault current limiter.

To this end, a method is proposed for controlling a superconducting electrical supply line, the method being carried out in a control circuit of said supply line and comprising the steps:
i) obtaining a piece of information representative of a first electric current in said superconducting electrical supply line,
ii) comparing said piece of information representative of a first electric current in said superconducting electrical supply line with a first predetermined threshold value, and,
iii) if said piece of information representative of a first electric current is greater than or equal to the first predetermined threshold value, generating a current, referred to as the second current, in a superconducting coil arranged in the vicinity of said superconducting electrical supply line and configured to emit a magnetic field, said superconducting electrical supply line being configured to receive said magnetic field, the value of said second current being determined on the basis of said piece of information representative of said first current.

It is thus advantageously possible to dynamically regulate the current in a superconducting electrical supply line by adjusting a limitation of the current according to the needs for electrical distribution. The invention thus enables protection of the electrical supply line in the event of a detected fault, as well as an improvement in the stability of said electrical supply line.

According to one embodiment, the method further comprises a step of melting of a calibrated break zone of the electrical supply line when the first electric current has an intensity greater than a second predetermined threshold value for a predetermined time.

Another object of the invention is a control circuit for a superconducting electrical supply line, the control circuit comprising electronic circuitry configured for:
i) obtaining a piece of information representative of a first electric current in said superconducting electrical supply line,
ii) comparing said piece of information representative of a first electric current in said superconducting electrical supply line with a first predetermined threshold value, and,
iii) if said piece of information representative of a first electric current is greater than or equal to the predetermined threshold value, generating a second current in a superconducting coil arranged in the vicinity of said superconducting electrical supply line and configured to emit a magnetic field, said superconducting electrical supply line being configured to receive said magnetic field, the value of said second current being determined on the basis of said piece of information representative of said first current.

Advantageously, the control circuit for a superconducting electrical supply line as mentioned above further comprises a calibrated break zone of the superconducting electrical supply line configured to melt when the first electric current is greater than a second predetermined threshold value for a predetermined time.

Another object of the invention is a control system for a superconducting electrical supply line comprising a control circuit as previously described and a superconducting coil supplied with power by the control circuit and arranged in the vicinity of the electrical supply line and configured to emit a magnetic field, said superconducting electrical supply line being configured to receive said magnetic field.

The invention also relates to an aircraft comprising at least one control circuit for a superconducting supply line as previously described, or a control system as cited above.

The invention additionally relates to a computer program product comprising program code instructions for carrying out the steps of the method as described when said program is executed by a processor of a control circuit of a superconducting electrical supply line, and a storage medium comprising such a computer program product.

### BRIEF DESCRIPTION OF THE DRAWINGS

The features of the invention mentioned above, as well as others, will become clearer on reading the following description of an exemplary embodiment, said description being given in relation to the attached figures:

FIG. 1 illustrates a superconducting electrical supply line equipped with a current control circuit according to an embodiment;

FIG. 2 illustrates a variant of the superconducting electrical supply line equipped with a current control circuit already shown in FIG. 1;

FIG. 3 is a flow diagram illustrating a method for controlling a superconducting electrical supply line, carried out in a control circuit, according to an embodiment;

FIG. 4 schematically illustrates an exemplary internal architecture of a controller device operating in a control circuit for a superconducting electrical supply line, according to an embodiment; and,

FIG. 5 illustrates an aircraft comprising a controlled superconducting electrical supply line according to an embodiment.

### DETAILED DESCRIPTION OF THE PREFERRED EMBODIMENTS

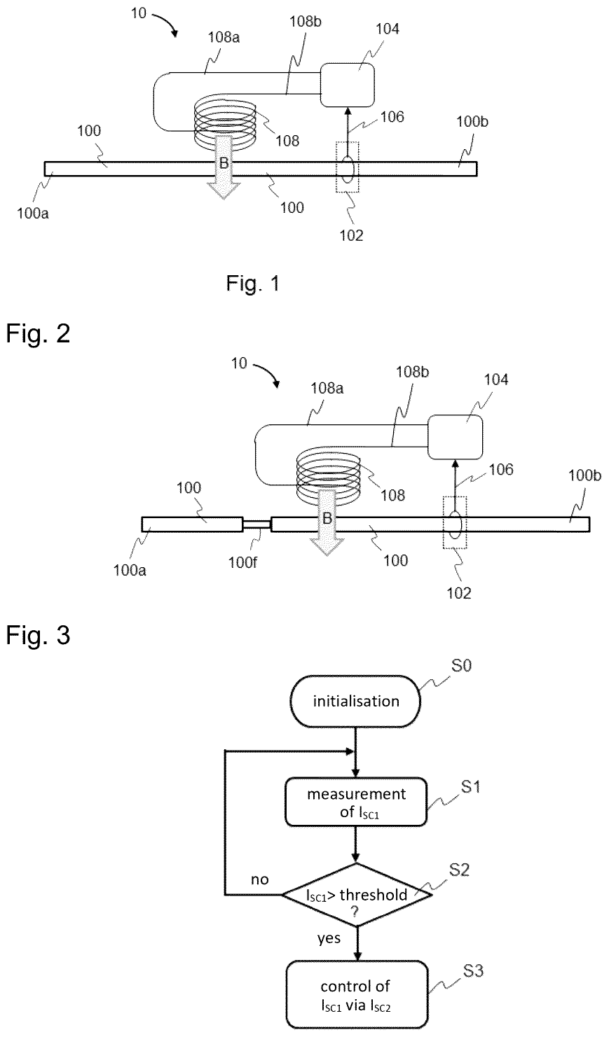

FIG. 1 is a schematic representation of a control circuit 10 for a superconducting electrical supply line 100. The superconducting electrical supply line 100 consists of at least one superconducting material and is subject to satisfactory conditions for operation of the superconducting electrical supply line 100 in the superconducting state. The superconducting operating conditions of the superconducting electrical supply line 100 comprise, in particular, temperature conditions, magnetic environment conditions and current density conditions. The superconducting electrical supply line 100 has two ends 100a and 100b, respectively connected to an electrical energy source and to a receiving device, circuit or system consuming electrical energy (not shown in the figure). According to an embodiment, the superconducting electrical supply line 100 has the form of a strip or a cable. Advantageously, a current sensor 102 is arranged on the superconducting electrical supply line 100 and is configured to deliver, to a controller device 104, a piece of information representative of the intensity of the current flowing in the superconducting electrical supply line 100. The current sensor 102 delivers the piece of information representative of the current flowing in the superconducting electrical supply line 100 to the controller device 104 via a link 106, also here called the connection link 106. According to an embodiment, the current sensor 102 is an electronic device which comprises one or more conductive windings arranged around the superconducting electrical supply line 100 and the terminals of which are respectively connected to current measurement inputs of the current sensor 102, which then sends, to the controller device 104 via the connection link 106, an analogue or digital quantity, the amplitude or value of which is proportional to the intensity of the measured electric current. According to an alternative embodiment, the one or more windings are directly connected to inputs of the controller device 104, and the terminals of the one or more windings then jointly constitute the connection link 106. According to an embodiment, the amplitude or the value addressed by the current sensor 102 is defined during a laboratory calibration phase and is taken from a table of values stored in a non-volatile memory of the current sensor 102. The control circuit 10 of the superconducting electrical supply line 100 further comprises a superconducting winding 108, also here referred to as a “coil” 108, physically arranged in the vicinity of the superconducting electrical supply line 100, such that when an electric current flows in the coil 108, an induced magnetic field is applied to the superconducting electrical supply line 100, the induced magnetic field being such as to modify the superconductivity conditions of the superconducting electrical supply line 100 and, in particular, such as to initiate a quench phenomenon able to increase the resistivity of the superconducting electrical supply line 100 and thus to increase the electrical resistance. In a variant, the magnetic field lines generated by the coil 108 can be guided within a magnetic circuit produced by using an assembly of ferromagnetic materials. The coil 108 comprises two terminal conductors 108a and 108b, also here called poles or terminals, connected to outputs of a current generator internal to the controller device 104, and the controller device 104 is configured to deliver a current generated in the coil 108, the intensity of which is a function of a piece of information representative of the current flowing in the superconducting electrical supply line 100. Alternatively, the controller device 104 can comprise a controller having the function of acquiring the current measurement and delivering an order to supply current to the coil 108, as well as a power stage, connected to said controller, and having the function of generating the current in the coil 108 in response to the supply order received from the controller. In other words, if I_{SC2} (here called second current) is the intensity of the current in the coil 108 and I_{SC1} (here called first current) is the intensity of the current in the superconducting electrical supply line 100, then I_{SC2}=f(I_{SC1}) and f is a function defined during laboratory calibration tests so as to be able to implement, by the control circuit 10, a current limiter function in the superconducting electrical supply line 100. More specifically, the arrangement of the control circuit 10 is such that if a fault occurs in an electrical power distribution network connected to the superconducting electrical supply line 100, an increase in the intensity of the first current I_{SC1} is detected by the current sensor 102 and transmitted to the controller 104, which determines the second current I_{SC2} according to the value of the first current I_{SC1}, or, more precisely, according to a piece of information representative of the intensity of the first current I_{SC1}, so as to generate a magnetic field B induced in the coil 108 and consequently induced in the superconducting electrical supply line 100. The operating features of the superconducting electrical supply line 100 are then modified by the presence of the magnetic field B to which the supply line is subject and which leads to a so-called limit state which corresponds to the controlled appearance of a quench phenomenon, which phenomenon leads to an increase in the resistance of the superconducting electrical supply line 100 and thus the appearance of a voltage between its ends 100a and 100b, and consequently a reduction in the intensity of the current flowing there. Thus, the described arrangement of the control circuit 10 of the superconducting electrical supply line 100 makes it possible to cleverly and advantageously control the resistance of the supply line and thus to control the intensity of the current in the superconducting supply line 100, in the event of the appearance of a fault in an electrical distribution network connected to the electrical supply line 100. The presence of a fault is determined when the value of the intensity of the first current I1 which flows in the superconducting electrical supply line 100 becomes greater than or equal to a first predetermined threshold value.

Advantageously, the first predetermined threshold value can vary as a function of predetermined operating modes of the superconducting electrical supply line 100. For example, the first threshold value can be equal to a value corresponding to a moderate power distribution regime, or to another value corresponding to a nominal power distribution regime, or again to a value corresponding to a full power (maximum power) distribution regime.

FIG. 2 illustrates a variant of the control circuit 100 of the superconducting electrical supply line 100 according to which the superconducting electrical supply line 100 also has a (melting) break initiation zone 100f calibrated in order to melt when the intensity of the current in the superconducting electrical supply line 100 is greater than or equal to a second threshold value for a predetermined time (duration). Such a configuration can advantageously interrupt the flow of the current in the superconducting electrical supply line 100 (by breaking and opening said line) in the event of malfunction of the control circuit 10, for example due to a malfunction of the controller device 104. This consequently makes it possible to prevent or limit the effects induced by the introduction of a quench phenomenon and an excessive dissipation of energy due to the Joule effect in the power distribution systems described or in neighbouring systems.

FIG. 3 is a flow diagram which illustrates steps of a control method carried out by the control circuit 10 of the superconducting electrical supply line 100. A step S0 comprises initialization and configuration operations for all the systems present, aiming to obtain a nominal state defined as a normally operational configuration for use of the superconducting electrical supply line 100, of all the systems that this supply line supplies with power and of the control circuit 10. A step S1 comprises a measurement of the intensity of the first current I_{SC1} flowing in the superconducting electrical supply line 100 by the current sensor 102 and the supplying of a piece of information representative of this current intensity I_{SC1} to the control device 104 via the connection link 106.

During a step S2, the control device 104 reads the piece of information representative of the intensity of the current I_{SC1} which flows in the superconducting electrical supply line 100 and determines whether the current I_{SC1} is or is not greater than or equal to a first predetermined threshold value. If the current I_{SC1} is not greater than or equal to the first predetermined threshold value, then the method returns to step S1 in order to perform a new iteration of measurement and testing of the quantity in connection with steps S1 and S2 described above.

However, if at step S2 the current I_{SC1} is greater than or equal to the first predetermined threshold value without, however, reaching the second predetermined threshold value, above which the break zone 100f could start to melt, then the control device 104 generates current between the terminals 108a and 108b, in the coil 108, so as to increase the magnetic field B to which the superconducting electrical supply line 100 is subject, so as to increase its resistance and thus to reduce the value of the current I_{SC1}.

According to an embodiment, the controller device 104 reads a value of the second current I_{SC2} to be generated as a function of a table stored in a non-volatile memory which it incorporates, on the basis of the value of the first current I_{SC1} or on the basis of a piece of information representative of the value of the first current I_{SC1}. It should be noted that “value of the current”, “intensity of the current” or “value of the intensity of the current” are used interchangeably here to refer to an intensity of electric current flowing in a conducting or superconducting element.

According to an embodiment, when the first current I_{SC1} reaches the second predetermined threshold value for a predetermined duration T1, the melting break zone 100f melts and opens the superconducting electrical supply line 100 during a step S4, subsequent to step S3, which only occurs in the event of failure or malfunction of the control circuit 10, in particular in the presence of a fault current in the superconducting electrical supply line 100.

According to an embodiment, the control circuit 10 is configured so that the magnetic field B is zero when the first current I_{SC1} is less than the first threshold current value and so that the magnetic field B is progressively increased with an increase in the current I_{SC1} when the first current I_{SC1} is greater than the first threshold current value.

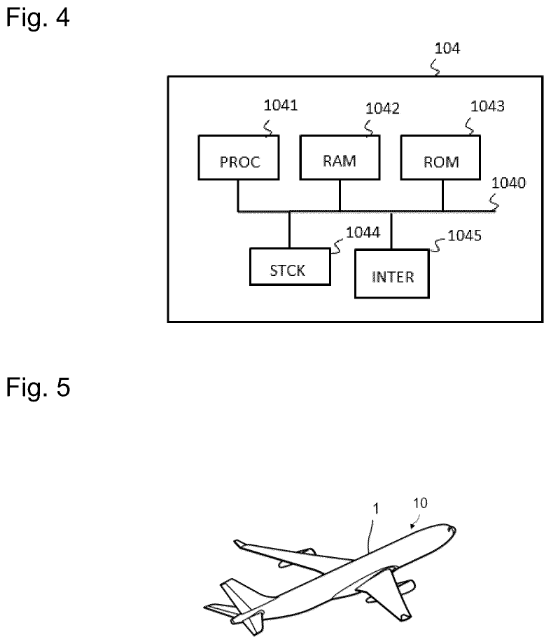

FIG. 4 is a diagram illustrating an example of internal architecture of the controller device 104 of the control circuit 10 for a superconducting electrical supply line, according to an embodiment.

According to the hardware architecture example shown in FIG. 4, the controller device 104 for a superconducting electrical supply line 100 then comprises, connected by a communication bus 1040: a processor or central processing unit (CPU) 1041; a random access memory (RAM) 1042; a read-only memory (ROM) 1043; a storage unit such as a hard disk (or a storage media reader, such as a secure digital card (SD card) reader 1044; at least one interface module 1045 enabling the controller device 104 to interact with devices present in control circuit 10, such as the current sensor 102 and the coil 108, for example. Advantageously, the interface module INTER 1065 comprises, in particular, input-output ports, digital-to-analogue converter inputs and analogue-to-digital converter inputs, pulse-width modulation controlled outputs, and more generally any type of interface, including power interfaces, used in particular for measuring a current in a superconducting electrical supply line and for generating a current in a superconducting electrical coil. In particular, the interface module INTER 1065 of the controller device 104 is configured to perform, in particular, electric current monitoring and electric current generation functions.

The processor 1041 is capable of executing instructions loaded into the RAM 1042 from the ROM 1043, from an external memory (not shown), from a storage medium (such as an SD card) or from a communication network. When the device 104 is switched on, the processor 1041 is capable of reading program code instructions from the RAM 1042 and of executing them. These instructions form a computer program causing the implementation, by the processor 1041, of all or part of a method described in connection with FIG. 3, or of all or part of the described variants of this method.

All or part of the method described in connection with FIG. 3, or its described variants, can be implemented in software form by execution of a set of instructions by a programmable machine, for example a digital signal processor (DSP) or a microcontroller, or can be implemented in hardware form by a dedicated machine or component, for example a field-programmable gate array (FPGA) or an application-specific integrated circuit (ASIC). In general, the controller device 104 for a superconducting electrical supply line comprises electronic circuitry configured to implement the methods described in connection with the control circuit 10 or the controller device 104. Obviously, the controller device 104 for a superconducting electrical supply line 100 also comprises all the usual elements present in a system comprising a control unit and its peripherals, such as a supply circuit, a supply monitoring circuit, one or more clock circuits, a reset circuit, associated input-output ports, interrupt inputs, bus drivers, this list not being exhaustive.

FIG. 5 illustrates an aircraft 1 advantageously comprising the control circuit 10 for a superconducting electrical supply line as previously described, which circuit comprises the controller device 104. The use of such a system aboard an aircraft comprising superconducting components makes it possible to offer an increased level of safety in the event of the appearance of a fault in an on-board electrical distribution network. In addition, it is advantageously possible to adapt the first threshold value of the first current I_{SC1} as a function of different flight phases of the aircraft 1. For example, the first threshold value during take-off of the aircraft 1 can be greater than the first threshold value during a cruising or descent phase of the aircraft 1.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method for controlling a superconducting electrical supply line, the method being carried out in a control circuit of said supply line and comprising the steps:
obtaining a piece of information representative of a first electric current in said superconducting electrical supply line;
comparing said piece of information representative of a first electric current in said superconducting electrical supply line with a first predetermined threshold value; and,
wherein when said piece of information representative of a first electric current is greater than or equal to the first predetermined threshold value, generating a current, referred to as the second current, in a superconducting coil arranged in the vicinity of said superconducting electrical supply line and configured to emit a magnetic field, said superconducting electrical supply line being configured to receive said magnetic field, the value of said second current being determined on the basis of said piece of information representative of said first current.

2. The method according to claim 1, further comprising a step of melting of a calibrated break zone of said superconducting electrical supply line when said first electric current has an intensity greater than a second predetermined threshold value for a predetermined time.

3. A control circuit for a superconducting electrical supply line, the control circuit comprising:
electronic circuitry configured for:
obtaining a piece of information representative of a first electric current in said superconducting electrical supply line,
comparing said piece of information representative of a first electric current in said superconducting electrical supply line with a first predetermined threshold value, and,
when said piece of information representative of a first electric current is greater than or equal to a predetermined threshold value, generating a second current in a superconducting coil arranged in the vicinity of said superconducting electrical supply line and configured to emit a magnetic field, said superconducting electrical supply line being configured to receive said magnetic field, the value of said second current being determined on the basis of said piece of information representative of said first current.

4. The control circuit for a superconducting electrical supply line according to claim 3, further comprising a calibrated break zone of said superconducting electrical supply line configured to melt when said first electric current is greater than a second predetermined threshold value for a predetermined time.

5. A control system for a superconducting electrical supply line comprising a control circuit according to claim 3 and a superconducting coil supplied with power by said control circuit and arranged in the vicinity of said superconducting electrical supply line.

6. An aircraft comprising at least one control circuit for a superconducting supply line according to claim 3.

7. An aircraft comprising a control system according to claim 5.

8. A computer program product comprising program code instructions for carrying out the steps of the method according to claim 1 when said program is executed by a processor of a control circuit for a superconducting electrical supply line.

9. A storage medium comprising a computer program product according to claim 8.
